(19) United States
(12) Patent Application Publication
(10) Pub. No.: US 2006/0129526 A1
(43) Pub. Date: Jun. 15, 2006

(54) System, apparatus and method of providing at least one of a plurality of serivce providers of a service based on a context in which the service is to be used

(76) Inventor: Richard Alan Sitze, Round Rock, TX (US)

Correspondence Address: IBM CORPORATION (VE);C/O VOLEL EMILE, P. O. BOX 202170, AUSTIN, TX, 78720-2170, US

(21) Appl. No.: 11/011,237

(22) Filed: Dec. 14, 2004

(51) Int. Cl. G06F 17/30

(52) U.S. Cl. 707/2

(57) ABSTRACT

A system, apparatus and method of providing at least one of a plurality of service providers of a service based on a context in which the service is to be used are provided. When a request, which includes an indication of a context in which the service is to be used, is received to locate the service, it is determined whether there is at least one service provider that is configured to be used specifically in the context in the request. If so, at least one instance of the at least one service provider is returned to the requester. Otherwise, at least one instance of a default service provider is returned, if available.

### BACKGROUND OF THE INVENTION

1. Technical Field

The present invention is directed to software applications. More specifically, the present invention is directed to a system, apparatus and method of providing at least one of a plurality of service providers of a service based on a context in which the service is to be used.

2. Description of Related Art

Java™, an object-oriented programming language developed by Sun Microsystems, Inc., is platform-independent, and networking/distributed-computing friendly. The Java platform provides for the development and deployment of reusable components, including Java classes and interfaces. A Java class (i.e., class) file is a compiled Java source file. Generally, a class file is generated for each class in a source file. A Java interface defines operations, also termed methods, that a class implements (i.e., declares what a class does).

Java programs may optionally be packaged into a Java ARchive (JAR) file. A JAR file is a file format that is used to bundle components required by a Java program. More specifically, a JAR file is a ZIP file that is created using a JAR utility. The JAR file may have a subdirectory of meta-information that is always named META-INF. The subdirectory may contain a manifest file that is always named MANIFEST.MF. The MANIFEST.MF file contains arbitrary information about the files in the archive, such as their encoding or language. In addition to the MANIFEST.MF file, the META-INF subdirectory may contain other subdirectories, programs, or files that represent meta-information a user wishes to include in the archive. For example, a user who has a service called my.java.ServiceInterface may store the name of a Java class that implements the service in a service provider file named META-INF/services/my.java.ServiceInterface.

A service is a well-known interface or an abstract class. An abstract class is a class that cannot be instantiated. Each service has a provider that offers the service. Put differently, a service provider is a specific implementation of a service.

As alluded to above, the subdirectory META-INF/services contains at least one service provider file. A service provider file is a file in which one or more service providers of the service (i.e., one or a plurality of different implementations of the service) may be specified. Note that, there may be a plurality of other JAR files each having at least one service provider file that specifies one or more service providers of each service. To determine which service providers implement a particular service, a service discovery tool is ordinarily used.

When a service discovery tool is invoked with the name of a service (e.g., my.java.ServiceInterface) as an attribute, the service discovery tool will locate the service provider file of the service in directory META-INF/services of all the JAR files that pertain to the service. The service discovery tool will also locate and return an instance of each one of the service providers of the service. However, although the service discovery tool may locate multiple service providers supporting a given service, there is no defined mechanism for either specifying or locating a service or services that would be appropriate in a particular context.

For example, in WebSphere Application Server or WAS (a product of IBM, Corp.), a high-speed non-validating XML parser may be required. If a service discovery tool is invoked with the name of the parser service (e.g., javax.xml.parsers.SAXParserFactory) as an attribute and the name of the service provider (e.g., com.ibm.xml.parsers.FastParser) is specified in the appropriate service provider file or files (e.g., META-INF/services/javax.xml.parsers.SAXParserFactory), the service discovery tool may locate the service provider file or files, read the parser name, load, instantiate, and return the com.ibm.xml.parsers.FastParser class as a service provider of the service.

A Java 2 Platform Enterprise Edition (J2EE) application that is in need of a parser may use a service discovery tool, or such a tool may be used to implement a standard command such as SAXParserFactory.newinstance ( ), to locate and instantiate the parser. A J2EE application is generally used to deploy Web-based enterprise applications online. As a quality of service feature, a more robust validating parser may be required. In such an instance, two different parsers will have to be used (i.e., a non-validating parser for WAS and a more robust validating parser for J2EE). While both types of the parser may be bound to the javax.xml.parsers.SAXParserFactory interface using a service definition file (or files), there is not presently a way to automatically determine which parser is appropriate for WAS or for a J2EE application.

Thus, there is a need to provide at least one of a plurality of service providers of a service based on a context in which the service is to be used.

### SUMMARY OF THE INVENTION

The present invention provides a system, apparatus and method of providing at least one of a plurality of service providers of a service based on a context in which the service is to be used. When a request, which includes an indication of a context in which the service is to be used, is received to locate the service, it is determined whether there is at least one service provider that is configured to be used specifically in the context in the request. If so, at least one instance of the at least one service provider is returned to the requester. Otherwise, at least one instance of a default service provider is returned, if available.

In a particular embodiment, it is determined whether there is a directory or subdirectory associated with the context in which the service is to be used and if so, whether there is a service provider file of the service located in the directory or subdirectory. If there is a service provider file located in the directory or subdirectory, at least one instance of a service provider is returned otherwise at least one instance of a default service provider is returned, if available.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a flowchart of a process that may be used to implement the invention.

FIG. 2 is an exemplary block diagram of a data processing system in which the present invention may be implemented.

### DETAILED DESCRIPTION OF THE PREFERRED EMBODIMENT

One of the basic command formats of the service discovery tool is Service.provider(Class type) to look a service provider up by type. Here, “type” may be replaced by any specific serviceInterface. If, on the other hand, a service provider is to be looked up by a service identifier, the format is Service.provider(String id). In this case, “id” may be replaced by any specific name of a serviceInterface.

The Java classes that implement a particular service interface may be listed in a service provider file (or files) whose name is of the form: META-INF/services/serviceInterface. Thus, in the case of the high-speed XML parser of the example in the Background of the Invention, the service provider file (or files) is META-INF/services/javax.xml.parsers.SAXParserFactory, and it would contain the service provider name “com.ibm.xml.parsers.FastParser”.

The present invention proposes to place the service provider file (or files) for a service that is specifically targeted to be used in a particular context (i.e., to be used by a particular requester) in file META-INF/services/context/serviceInterface. Again, in the case of the XML parser, the file is META-INF/services/context/javax.xml.parsers.SAXParserFactory. Therefore, the name of the class that implements the high-speed parser used by WAS may be placed in the service provider file (or files) META-INF/services/WAS/javax.xml.parsers.SAXParserFactory.

Further, the present invention proposes to have any requester that desires to employ a service that is particularly designed for its use to utilize a service discovery invocation of the form: Service.provider(String context, Class type). This will allow the service discovery tool to look for the service provider file (or files) in the context directory. For example, when the high-speed parser that is configured to be used by WAS is to be plugged into WAS, the service discovery tool may be invoked using the service discovery invocation of the form:Service.provider(“WAS”, javax.xml.parsers.SAXParserFactory.class).

If a service discovery is invoked using Service.provider(String context, Class type) and file META-INF/services/context/serviceInterface does not exist or the classes specified within serviceInterface cannot be loaded, then a default service provider file META-INF/services/serviceInterface may be used. To continue with the example above, if there is not a loadable parser specified in file (or files) META-INF/services/WAS/javax.xml.parsers.SAXParserFactory, or if the file (or files) does not exist, a default parser (or parsers), which may be specified in the service provider file (or files) META-INF/services/javax.xml.parsers.SAXParserFactory, may then be used.

In the above-disclosure of the invention, the service discovery tool was invoked using the command format Service.provider(String context, Class type). However, the invention is not thus restricted. Many other formats may be used. For example, Service.provider(Class CallingClass, Class type) may also be used. As the term CallingClass suggests, the class of the requester is used to determine the directory in which the service may be located. Further, it is even possible to use the format Service.provider(Class type) in order to use the invention. In this case, the calling class may be determined by examining the call-stack. Thus, various other formats may be used so long as a context, such as the requester of the service, may be gleaned from the invocation of the service discovery tool. And as before, if there is not a loadable service that is specifically implemented to be used by the requester, instances of default service providers may be returned. Consequently, the format of the service invocation used in the above-disclosure is for illustrative purposes only.

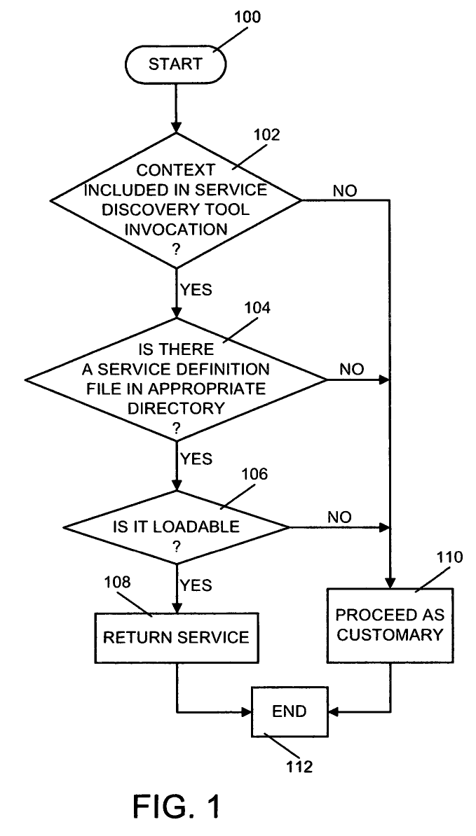

FIG. 1 is a flowchart of a process that may be used in implementing the invention. The process starts when the service discovery tool is invoked (step 100). Then, a check is made to determine whether a context is included in the invocation of the service discovery tool (step 102). Note that here, any format of the invocation of the service discovery tool may be used, including the customary format of Service.provider(Class type). In that case, the call-stack may be examined for a calling class resolution. Using the calling class, the context may then be determined. In any case, once the context is known, a check may be made to determine whether there is a specific service provider file (or files) that is associated with the context (step 104). If so, it may be determined if at least one service provider specified by the service provider file (or files) is loadable (step 106). If at least one service provider is loadable, it is loaded and an instance is returned to the requestor before the process ends (steps 108 and 110). If the result to any one of the tests or checks above is negative, the process may proceed as customary. That is, at least one instance of a generic or default version of the service provider, which may be specified in a default service provider file, may be returned to the requester before the process ends (steps 112 and 110).

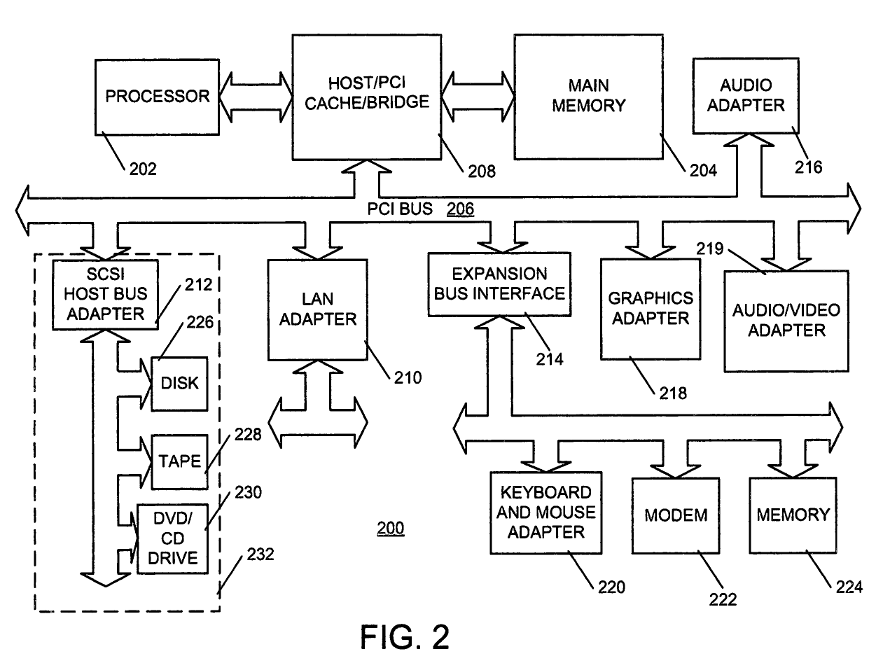

FIG. 2 is a data processing system on which the invention may be implemented. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. Small computer system interface (SCSI) host bus adapter 212 provides a connection for hard disk drive 226, tape drive 228, and CD-ROM/DVD drive 230. Typical PCI local bus implementations will support three or four PCI expansion slots or add-in connectors.

An operating system runs on processor 202 and is used to coordinate and provide control of various components within data processing system 200. The operating system may be a commercially available operating system, such as Windows XP™, which is available from Microsoft Corporation. An object oriented programming system such as Java may run in conjunction with the operating system and provide calls to the operating system from Java programs or applications executing on data processing system 200. As mentioned earlier, Java™ is a product of Sun Microsystems, Inc. The operating system, the object-oriented operating system, and applications or programs as well as the present invention may be located on storage devices, such as hard disk drive 226, and may be loaded into main memory 204 for execution by processor 202.

Those of ordinary skill in the art will appreciate that the hardware in FIG. 2 may vary depending on implementations. Other internal hardware or peripheral devices, such as flash ROM (or equivalent nonvolatile memory) or optical disk drives and the like, may be used in addition to or in place of the hardware depicted in FIG. 2. Also, the processes of the present invention may be applied to a multiprocessor data processing system.

As another example, data processing system 200 may be a stand-alone system configured to be bootable without relying on some type of network communication interface, whether or not data processing system 200 comprises some type of network communication interface. As a further example, data processing system 200 may be a Personal Digital Assistant (PDA) device, which is configured with ROM and/or flash ROM in order to provide non-volatile memory for storing operating system files and/or user-generated data.

The depicted example in FIG. 2 and above-described examples are not meant to imply architectural limitations. For example, data processing system 200 may also be a notebook computer or hand held computer in addition to taking the form of a PDA. Data processing system 200 also may be a kiosk or a Web appliance.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of providing at least one of a plurality of service providers of a service based on a context in which the service is to be used comprising the steps of:
receiving a request to locate the service;
determining, using the request, the context in which the service is to be used;
ascertaining whether there is at least one service provider that is configured to be used specifically in the context in the request; and
returning the at least one service provider if it is ascertained that there is at least one service provider that is configured to be used specifically in the context in the request.

2. The method of claim 1 wherein at least one default service provider is returned if it is determined that there is not at least one service provider that is configured to be used specifically in the context and the at least one default service provider is available.

3. The method of claim 1 wherein the step of ascertaining includes the step of determining whether there is a directory associated with the context in which the service is to be used.

4. The method of claim 3 wherein the step of ascertaining further includes the step of determining whether there is at least one service provider file associated with the service in the directory.

5. The method of claim 4 wherein if there is at least one service provider file associated with the service in the directory, it is determined whether there is at least one loadable service provider defined in the at least one service provider file.

6. A computer program product on a computer readable medium for providing at least one of a plurality of service providers of a service based on a context in which the service is to be used comprising:
code means for receiving a request to locate the service;
code means for determining, using the request, the context in which the service is to be used;
code means for ascertaining whether there is at least one service provider that is configured to be used specifically in the context in the request; and
code means for returning the at least one service provider if it is ascertained that there is at least one service provider that is configured to be used specifically in the context in the request.

7. The computer program product of claim 6 wherein at least one default service provider is returned if it is determined that there is not at least one service provider that is configured to be used specifically in the context and the at least one default service provider is available.

8. The computer program product of claim 6 wherein the ascertaining code means includes code means for determining whether there is a directory associated with the context in which the service is to be used.

9. The computer program product of claim 8 wherein the ascertaining code means further includes code means for determining whether there is at least one service provider file associated with the service in the directory.

10. The computer program product of claim 9 wherein if there is at least one service provider file associated with the service in the directory, it is determined whether there is at least one loadable service provider defined in the at least one service provider file.

11. An apparatus for providing at least one of a plurality of service providers of a service based on a context in which the service is to be used comprising:
means for receiving a request to locate the service;
means for determining, using the request, the context in which the service is to be used;
means for ascertaining whether there is at least one service provider that is configured to be used specifically in the context in the request; and
means for returning the at least one service provider if it is ascertained that there is at least one service provider that is configured to be used specifically in the context in the request.

12. The apparatus of claim 11 wherein at least one default service provider is returned if it is determined that there is not at least one service provider that is configured to be used specifically in the context and the at least one default service provider is available.

13. The apparatus of claim 11 wherein the ascertaining means includes means for determining whether there is a directory associated with the context in which the service is to be used.

14. The apparatus of claim 13 wherein the ascertaining means further includes means for determining whether there is at least one service provider file associated with the service in the directory.

15. The apparatus of claim 14 wherein if there is at least one service provider file associated with the service in the directory, it is determined whether there is at least one loadable service provider defined in the at least one service provider file.

16. A system for providing at least one of a plurality of service providers of a service based on a context in which the service is to be used comprising:
at least one storage device for storing code data; and
at least one processor for processing the code data to receive a request to locate the service, to determine, using the request, the context in which the service is to be used, to ascertain whether there is at least one service provider that is configured to be used specifically in the context in the request, and to return the at least one service provider if it is ascertained that there is at least one service provider that is configured to be used specifically in the context in the request.

17. The system of claim 16 wherein at least one default service provider is returned if it is determined that there is not at least one service provider that is configured to be used specifically in the context and the at least one default service provider is available.

18. The system of claim 16 wherein the code data is further processed to determine whether there is a directory associated with the context in which the service is to be used.

19. The system of claim 18 wherein the code data is further processed to determine whether there is at least one service provider file associated with the service in the directory.

20. The system of claim 19 wherein if there is at least one service provider file associated with the service in the directory, it is determined whether there is at least one loadable service provider defined in the at least one service provider file.
